(19) United States
(12) Patent Application Publication
(10) Pub. No.: US 2010/0056334 A1
(43) Pub. Date: Mar. 4, 2010

(54) FAIL-SAFE MECHANISM FOR AUTOMATIC TRANSMISSION, AND FAIL-SAFE VALVE PROVIDED IN THE FAIL-SAFE MECHANISM

(75) Inventors: Hiroomi Toi, Aichi-ken (JP); Shinichi Ito, Aichi-ken (JP); Akiko Nishimine, Aichi-ken (JP); Kenichi Tsuchida, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignees: TOYOTA JIDOSHA KABUSHIKI KAISHA, Toyota-shi (JP); AISIN AW CO., LTD, Anjo-shi (JP)

(21) Appl. No.: 12/595,354

(22) PCT Filed: Apr. 11, 2008
(86) PCT No.: PCT/IB2008/000878

§ 371 Date: Oct. 9, 2009

(30) Foreign Application Priority Data
Apr. 12, 2007 (JP) 2007-104567

(51) Int. Cl. F16H 61/26

(52) U.S. Cl. 477/158

(57) ABSTRACT

In a fail-safe mechanism for an automatic transmission (3), when a predetermined gearshift (Rev) is positioned in the automatic transmission (3) during a non-failure state of the automatic transmission, a first valve unit (70) moves from a non-failure position toward a failure position as the oil pressure for positioning the predetermined gearshift (Rev) is caused to act on a fail-safe valve (50) as an extraneous matter-discharging oil pressure (PR).

### BACKGROUND OF THE INVENTION

1. Field of the Invention

The invention relates to a fail-safe mechanism for an automatic transmission mounted in a motor vehicle or the like, and to a fail-safe valve provided in the fail-safe mechanism. More particularly, the invention relates to an improvement of a fail-safe valve constructed to be able to discharge extraneous matter or the like.

2. Description of the Related Art

As an example of the automatic transmissions mounted in motor vehicles and the like, a planetary gear type automatic transmission that sets a gearshift position (gear step) by using clutches, brakes and a planetary gear device is generally known. In a vehicle in which this type of automatic transmission is mounted, a target gearshift position is calculated on the basis of the vehicle speed and the accelerator operation amount (or the degree of throttle opening), and an appropriate gearshift position is automatically set by engaging or releasing the clutches and the brakes, which are friction engagement elements, into such predetermined states as to achieve the target gearshift position.

In this type of automatic transmission, if there occurs a failure (hereinafter, referred to also as “fail”) in which not only the friction engagement elements that need to assume engaged states in order to establish a predetermined gearshift position but also another friction engagement element is engaged, there is possibility that the automatic transmission may fall into a so-called interlocked state. To avoid such a situation, a construction in which a fail-safe valve is provided in a hydraulic control circuit of an automatic transmission is disclosed in, for example, Japanese Patent Application Publication No. 2001-248723 (JP-A-2001-248723). The fail-safe valve is actuated at the time of a fail state to avoid the aforementioned interlocked state by switching (a valve unit, such as a spool or the like, moves) so as to block the supply of oil pressure, for example, to one friction engagement element (e.g. a brake) (so as to drain the oil pressure).

However, a common fail-safe valve is not actuated unless the aforementioned fail occurs on the automatic transmission, there often occurs a situation in which the switching operation (the moving operation of the valve unit) is not performed for a long period of time. Therefore, there is possibility of occurrence of a failure of the valve itself (so-called valve sticking).

A cause of the occurrence of the valve sticking is contamination of oil with very small extraneous matter, such as abrasion powder of a spool, sludge, etc., that is produced as the automatic transmission is used for a long period of time. That is, as for various valves that are actuated in association with the gear shift operation (valves other than the fail-safe valve), if the very small extraneous matter flows into an oil chamber, the valve switching operation, which is relatively frequently performed, forces the very small extraneous matter out via a drain port or the like, so that the very small extraneous matter substantially never accumulates or becomes caught in between the valve body and the spool, or the like.

However, as for the fail-safe valve, which is not actuated unless the automatic transmission is in a fail state, it sometimes happens that the very small extraneous matter accumulates (becomes caught) in a gap between the valve body (sleeve) and a valve unit, such as a plunger or the like, (e.g., a gap formed due to errors in manufacture or the like). In such a situation, if the fail of the automatic transmission actually occurs, the very small extraneous matter may become a movement resistance against the plunger or the like, giving rise to the possibility that the operation of the fail-safe valve (a fail-safe operation for avoiding the interlocked state) cannot be favorably performed.

To overcome this problem, the fail-safe valve disclosed in Japanese Patent Application Publication No. 2004-36670 (JP-A-2004-36670) avoids a situation in which very small extraneous matter accumulates between the plunger and the valve body, by actuating (moving) the plunger of the fail-safe valve every time the engine stops.

Concretely, as shown in FIG. 8, the fail-safe valve has a construction in which an outside spring 501 that urges the valve element 500 toward a normal-state movement position (a position assumed when the fail is not present, that is, the position shown by the left side of the illustration in FIG. 8), an inside spring 503 that is fitted between the valve element 500 and the plunger 502 and that urges the plunger 502 toward a fail-state movement position (a position assumed when the fail is present, that is, the position shown by the right side of the illustration in FIG. 8), and a washer 504 that serves as seats for the springs 501, 503 are attached. Then, in a situation where the engine is at a stop and oil pressure does not act on the valve element 500 or the plunger 502, the plunger 502 is moved toward the fail-state movement position by the urging force of the inside spring 503. Therefore, the very small extraneous matter present between the plunger 502 and the valve body 505 is discharged, so that the sliding resistance between the two components is reduced. As a result, the fail-safe operation performed in the case where the fail occurs in the automatic transmission can be favorably performed.

However, in the technology described in the document JP-A-2004-036670, it is necessary to newly attach the inside spring 503 fitted between the valve element 500 and the plunger 502 and the washer 504 that serves as the seats for the springs 501, 503.

Therefore, since there is a need to secure insertion space for these members, there is possibility of causing a size increase and a weight increase of the entire fail-safe valve. Besides, there is possibility of causing a rise in production cost associated with an increase in the number of component parts, and possibility of causing an increase in the number of assembly man-hours and a complication of the assembly operation.

### SUMMARY OF THE INVENTION

Accordingly, the invention provides a fail-safe mechanism for an automatic transmission which is capable of maintaining the fail-safe function that is to be performed at the time of the fail of the automatic transmission and of performing extraneous matter discharge by actuating a valve unit at predetermined timing without requiring an increase in the number of component parts, and also provides a fail-safe valve that is provided in the fail-safe mechanism for an automatic transmission.

In the invention, during a non-failure state of the automatic transmission, the oil pressure for performing a shift operation of the automatic transmission is utilized as a drive force for performing the extraneous matter discharge; more specifically, the foregoing oil pressure that is generated only at a predetermined timing (e.g., the time of reverse movement of the vehicle) is caused to act on a fail-safe valve, so that a valve unit is moved by this oil pressure so as to perform the extraneous matter discharge. That is, when a predetermined shift operation is performed, the extraneous matter discharge that utilizes the oil pressure is performed.

An automatic transmission fail-safe mechanism in accordance with a first aspect of the invention is an automatic transmission fail-safe mechanism which is provided in a hydraulic control circuit of an automatic transmission that changes gear ratio by controlling oil pressure with respect to a plurality of friction engagement elements to selectively engage the plurality of friction engagement elements, and which has a fail-safe valve whose first valve unit moves from a non-failure position to a failure position when the automatic transmission is under failure. When a predetermined gearshift is positioned in the automatic transmission during a non-failure state of the automatic transmission, the fail-safe mechanism of the automatic transmission causes the first valve unit to move from the non-failure position toward the failure position by causing the oil pressure for positioning the predetermined gearshift to act on the fail-safe valve as an extraneous matter-discharging oil pressure.

According to the first aspect, in the case where ea predetermined gearshift position (e.g., a reverse gearshift position) is established by a shift operation of the automatic transmission, the oil pressure generated to establish the gearshift position acts on the fail-safe valve, so that the first valve unit, having been at the non-failure position, moves toward the failure position. Therefore, if very small extraneous matter should exist between the first valve unit and the valve body, the very small extraneous matter will be removed as the first valve unit moves. This operation is executed every time the predetermined gearshift position is established (e.g., every time the vehicle travels reversely). Therefore, the valve sticking caused by the first valve unit of the fail-safe valve remaining unmoved for a long period of time can be resolved. Besides, since such a member as a spring or the like is not used as means for moving the first valve unit in order to perform the extraneous matter discharge, there is no need to add a component part (e.g., an inside spring disclosed in JP-A-2004-036670, or the like) to the fail-safe valve. Therefore, size increase and weight increase of the fail-safe control valve can be prevented, and the rise in production cost can be curbed. Furthermore, increase in the assembly man-hours and complication of the assembly operation can be prevented. Incidentally, the predetermined gearshift position that causes the extraneous matter discharge is not limited to the reverse gearshift position, but may also be a gearshift position of forward-travel gearshift positions (e.g., the first gearshift position).

In the automatic transmission fail-safe mechanism in accordance with the first aspect, the predetermined gearshift being positioned when the first valve unit moves from the non-failure position toward the failure position may be a reverse gearshift. That is, the extraneous matter discharge may be executed when the automatic transmission is set at the reverse gearshift position.

According to the foregoing construction, it is not that the oil pressure provided specifically for moving the first valve unit toward the failure position is supplied to the fail-safe valve during the forward travel of the vehicle. Therefore, the construction does not cause any inconvenience or the like regarding the shift operation performed during the forward travel of the vehicle.

The automatic transmission fail-safe mechanism in accordance with the first aspect may also have a construction as follows. That is, a valve element and the first valve unit are coaxially inserted so as to be movable relative to each other within a valve body of the fail-safe valve, and an extraneous matter-discharging oil chamber is provided between the valve element and the first valve unit, and a line pressure oil chamber in which a line pressure of the hydraulic control circuit acts is provided between the first valve unit and the valve body. A pressure receiving area of an end surface of the first valve unit that faces the extraneous matter-discharging oil chamber is set larger than a pressure receiving area of an end surface of the first valve body that faces the line pressure oil chamber. An oil pressure that is substantially equal to the line pressure acts in the extraneous matter-discharging oil chamber if the predetermined gearshift is positioned during the non-failure state of the automatic transmission.

According to this construction, when the predetermined gearshift position is established, an oil pressure substantially equal to the line pressure acting in the line pressure oil chamber acts in the extraneous matter-discharging oil chamber. That is, substantially equal oil pressures act on the end surface of the first valve unit that faces the extraneous matter-discharging oil chamber and on the end surface of the first valve unit that faces the line pressure oil chamber. Since the pressure receiving area of the end surface of the first valve unit that faces the extraneous matter-discharging oil chamber is set larger than the pressure receiving area of the end surface of the first valve unit that faces the line pressure oil chamber, the pressing force (thrust) from the extraneous matter-discharging oil chamber side, as one of the forces that act on the first valve unit in the center axis directions, is larger than the force from the opposite side, so that the first valve unit moves toward the line pressure oil chamber side. Therefore, the very small extraneous matter present between an outer peripheral surface of the first valve unit and an inner peripheral surface of the valve body is removed.

The automatic transmission fail-safe mechanism in accordance with the first aspect may further include: a first oil passageway as a supply oil passageway of the oil pressure for positioning the predetermined gearshift; a second oil passageway as a drain oil passageway; a branch oil passageway that connects the first oil passageway and the second oil passageway in communication; and a second valve unit provided in the second oil passageway at a drain side of a connecting position between the second oil passageway and the branch oil passageway. If the predetermined gearshift is positioned during the non-failure state of the automatic transmission, the oil pressure for positioning the predetermined gearshift may be supplied via the branch oil passageway to the extraneous matter-discharging oil chamber by closing the second valve unit, so that the oil pressure acts on the fail-safe valve as the extraneous matter-discharging oil pressure.

In the automatic transmission fail-safe mechanism in accordance with the first aspect, a valve element and the first valve unit may be in contact with each other, when the predetermined gearshift is positioned in the automatic transmission during the non-failure of the automatic transmission, the valve element may move together with the first valve unit from the non-failure position toward the failure position.

An automatic transmission fail-safe mechanism in accordance with a second aspect of the invention is an automatic transmission fail-safe mechanism which is provided in a hydraulic control circuit of an automatic transmission that changes gear ratio by controlling oil pressure with respect to a plurality of friction engagement elements to selectively engage the plurality of engagement elements, and which has a fail-safe valve whose first valve unit moves from a non-failure position to a failure position when the automatic transmission is under failure. When a predetermined friction engagement element of the plurality of friction engagement elements is engaged during a non-failure state of the automatic transmission, the fail-safe mechanism of the automatic transmission causes the first valve unit to move from the non-failure position toward the failure position by causing the oil pressure for engaging the predetermined friction engagement element to act on the fail-safe valve as an extraneous matter-discharging oil pressure.

In the second aspect, too, such a member as a spring or the like is not used as means for moving the first valve unit so as to perform the extraneous matter discharge. Therefore, as in the first aspect of the invention, size increase and weight increase of the fail-safe control valve can be prevented, and the rise in production cost can be curbed. Furthermore, increase in the assembly man-hours and complication of the assembly operation can be prevented.

In the automatic transmission fail-safe mechanism in accordance with the second aspect, the predetermined friction engagement element being engaged when the first valve unit moves from the non-failure position toward the failure position may be a friction engagement element that is not engaged if a forward travel gearshift of the automatic transmission is positioned, and that is engaged if a reverse gearshift of the automatic transmission is positioned. That is, in this construction, too, the extraneous matter discharge may be executed when the reverse gearshift position of the automatic transmission is established.

According to the foregoing construction, it is not that the oil pressure provided specifically for moving the first valve unit toward the failure position is supplied to the fail-safe valve during the forward travel of the vehicle. Therefore, the construction does not cause any inconvenience or the like regarding the shift operation performed during the forward travel of the vehicle.

An automatic transmission fail-safe mechanism in accordance with a third aspect of the invention is an automatic transmission fail-safe mechanism which is provided in a hydraulic control circuit of an automatic transmission that changes gear ratio by controlling oil pressure with respect to a plurality of friction engagement elements to selectively engage the plurality of friction engagement elements, and which has a fail-safe valve whose first valve unit is moved from a non-failure position to a failure position by a plurality of oil pressures that do not simultaneously occur during the non-failure state of the automatic transmission as the plurality of the oil pressures act from individual oil pressure supply ports. When a predetermined friction engagement element of the plurality of friction engagement elements is engaged during the non-failure state of the automatic transmission, the fail-safe mechanism of the automatic transmission causes the first valve unit to move from the non-failure position toward the failure position by causing the oil pressure for engaging the predetermined friction engagement element to act on the fail-safe valve from a drain port as an extraneous matter-discharging oil pressure.

According to the third aspect, except in a state in which a predetermined friction engagement element is engaged, the draining of oil from the drain port is performed. Then, when a state in which the predetermined friction engagement element is engaged comes about, the oil pressure for engaging the predetermined friction engagement element comes to act on the fail-safe valve from the drain port, so that the oil pressure acting on the fail-safe valve moves the first valve unit from the non-failure position to the failure position. Then, the movement of the first valve unit removes the very small extraneous matter present between the first valve unit and the valve body. Therefore, according to the third aspect, too, size increase and weight increase of the fail-safe control valve can be prevented, and the rise in production cost can be curbed, as in the first aspect of the invention. Furthermore, increase in the assembly man-hours and complication of the assembly operation can be prevented. Incidentally, examples of the concrete construction for causing the drain port of the fail-safe valve to function as an oil pressure supply port for moving the first valve unit include a construction in which an oil passageway connecting to the drain port is provided with an open-close valve, and this open-close valve is closed (the closure prohibits the drain of oil), etc. Besides, another construction may also be provided for functioning the drain port to function as an oil pressure supply port.

In the automatic transmission fail-safe mechanism in accordance with the third aspect, the drain port may be provided for draining oil when the vehicle is traveling forward, and if the oil pressure for engaging the predetermined friction engagement element acts on the fail-safe valve from the drain port when the vehicle reversely moves, the first valve unit may move from the non-failure position toward the failure position. That is, in this construction, too, the extraneous matter discharge may be executed in the case where the reverse gearshift position of the automatic transmission is established.

According to the foregoing construction, it is not that the oil pressure provided specifically for moving the first valve unit toward the failure position is supplied to the fail-safe valve during the forward travel of the vehicle. Therefore, the construction does not cause any inconvenience or the like regarding the shift operation performed during the forward travel of the vehicle.

Furthermore, in the automatic transmission fail-safe mechanism in accordance with the third aspect, the drain port may communicate with an extraneous matter-discharging oil chamber that is provided between the valve element and the first valve unit.

Furthermore, the automatic transmission fail-safe mechanism in accordance with the foregoing aspect may also have a construction as follows. That is, a valve element and the first valve unit are coaxially inserted so as to be movable relative to each other within a valve body of the fail-safe valve, and an extraneous matter-discharging oil chamber is provided between the valve element and the first valve unit, and a line pressure oil chamber in which a line pressure of the hydraulic control circuit acts is provided between the first valve unit and the valve body. A pressure receiving area of an end surface of the first valve unit that faces the extraneous matter-discharging oil chamber is set larger than a pressure receiving area of an end surface of the first valve body that faces the line pressure oil chamber. An oil pressure substantially equal to the line pressure acts in the extraneous matter-discharging oil chamber if the predetermined friction engagement element is engaged during the non-failure state of the automatic transmission.

According to this construction, when the predetermined friction engagement element is engaged, an oil pressure substantially equal to the line pressure acting in the line pressure oil chamber acts in the extraneous matter-discharging oil chamber. Then, in this embodiment, too, since the pressure receiving area of the end surface of the first valve unit that faces the extraneous matter-discharging oil chamber is set larger than the pressure receiving area of the end surface of the first valve unit that faces the line pressure oil chamber, the pressing force (thrust) from the extraneous matter-discharging oil chamber side, as one of the forces that act on the first valve unit in the center axis directions, is larger than the force from the opposite side, so that the first valve unit moves toward the line pressure oil chamber side. Therefore, the very small extraneous matter present between an outer peripheral surface of the first valve unit and an inner peripheral surface of the valve body is removed.

Furthermore, the automatic transmission fail-safe mechanism in accordance with the foregoing aspect may further include: a first oil passageway as a supply oil passageway of the oil pressure for positioning the predetermined gearshift; a second oil passageway as a drain oil passageway; a branch oil passageway that connects the first oil passageway and the second oil passageway in communication; and a second valve unit provided in the second oil passageway at a drain side of a connecting position between the second oil passageway and the branch oil passageway. If the predetermined friction engagement element is engaged during the non-failure state of the automatic transmission, the oil pressure for engaging the predetermined friction engagement element may be supplied via the branch oil passageway to the extraneous matter-discharging oil chamber by closing the second valve unit, so that the oil pressure acts on the fail-safe valve as the extraneous matter-discharging oil pressure.

Furthermore, in the automatic transmission fail-safe mechanism in accordance with the foregoing aspect, the valve element and the first valve unit may be in contact with each other, and when a predetermined friction engagement element of the plurality of friction engagement elements may be engaged during the non-failure state of the automatic transmission, the valve element may move together with the first valve unit from the non-failure position toward the failure position.

Furthermore, in the automatic transmission fail-safe mechanism in accordance with the foregoing aspect, an outside diameter of a pressure receiving area of an end surface of the first valve unit that faces the extraneous matter-discharging oil chamber may be set approximately 1.2 times as large as an outside diameter of a pressure receiving area of an end surface of the first valve unit that faces the line pressure oil chamber.

Furthermore, in the automatic transmission fail-safe mechanism in accordance with the foregoing aspect, in the first valve unit, a first land having an end surface having an end surface that faces the extraneous matter-discharging oil chamber and a second land having an end surface that faces the line pressure oil chamber are integrally formed.

Furthermore, in the automatic transmission fail-safe mechanism in accordance with the foregoing aspect, the first valve unit may be a plunger.

Furthermore, in the automatic transmission fail-safe mechanism in accordance with the foregoing aspect, the fail-safe valve may be a clutch apply control valve.

A fail-safe valve in accordance with a fourth aspect of the invention is a fail-safe valve provided in the automatic transmission fail-safe mechanism according to any one of the foregoing aspects in which a valve element and the first valve unit are coaxially inserted so as to be movable relative to each other within a valve body, and a spring that urges the valve element toward the non-failure position is attached between the valve body and the valve element, and the first valve unit moves from the non-failure position toward the failure position as the extraneous matter-discharging oil pressure acts between the valve element and the first valve unit.

According to the fourth aspect, during a non-failure state of the automatic transmission, the oil pressure for performing a shift operation of the automatic transmission is utilized as a drive force for performing the extraneous matter discharge from the fail-safe valve; more specifically, the foregoing oil pressure that is generated only at a predetermined timing (e.g., the time of establishment of the reverse gearshift position) is caused to act on a fail-safe valve, so that a valve unit is moved by this oil pressure so as to perform the extraneous matter discharge. Therefore, when a predetermined shift operation is performed, the extraneous matter discharge be performed. Due to the extraneous matter discharge, high reliability of the fail-safe valve can be maintained. Besides, it is not that the urging force of the spring, or the like is used as a drive force for moving the first valve unit so as to perform the extraneous matter discharge. Therefore, size increase and weight increase of the fail-safe control valve can be prevented, and the rise in production cost can be curbed. Furthermore, increase in the assembly man-hours and complication of the assembly operation can be prevented.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a schematic construction diagram showing a driving device of a vehicle in accordance with an embodiment of the invention;

FIG. 2 is a diagram showing the states of engagement of clutches and brakes in an automatic transmission in accordance with the embodiment of the invention, separately for individual gearshift positions;

FIG. 3 is a block diagram showing a construction of a control system, including an ECU and the like, in accordance with the embodiment of the invention;

FIG. 4 is a diagram showing a shift map that is used for a shift control in accordance with the embodiment of the invention;

FIG. 5 is a diagram showing a hydraulic control circuit related to a clutch apply control valve, clutches and brakes in accordance with the embodiment of the invention;

FIG. 6 is an enlarged view showing a plunger of the clutch apply control valve and its peripheral portions in accordance with the embodiment of the invention;

FIG. 7 is a diagram showing a state of operation of the clutch apply control valve at the time of an extraneous matter discharge in accordance with the embodiment of the invention; and

FIG. 8 is a diagram showing a fail-safe valve in accordance with a related art.

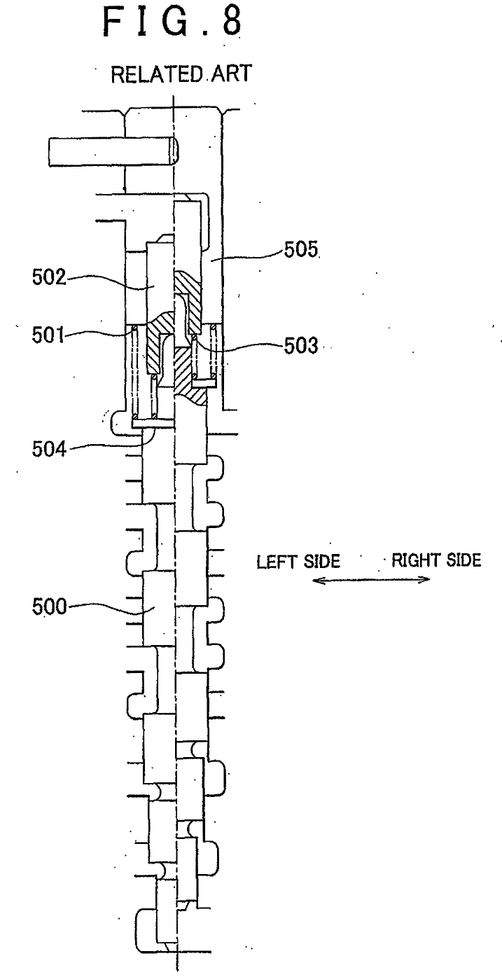

### DETAILED DESCRIPTION OF EMBODIMENTS

Embodiments of the invention will be described hereinafter with reference to the drawings. As an embodiment, a case where the invention is applied to an automatic transmission mounted in an FF (front engine, front wheel drive) vehicle will be described. Prior to description of the construction and operations of a fail-safe valve that is a feature of the embodiment, basic operations and the like of a vehicular power train and an automatic transmission of the vehicle will be described.

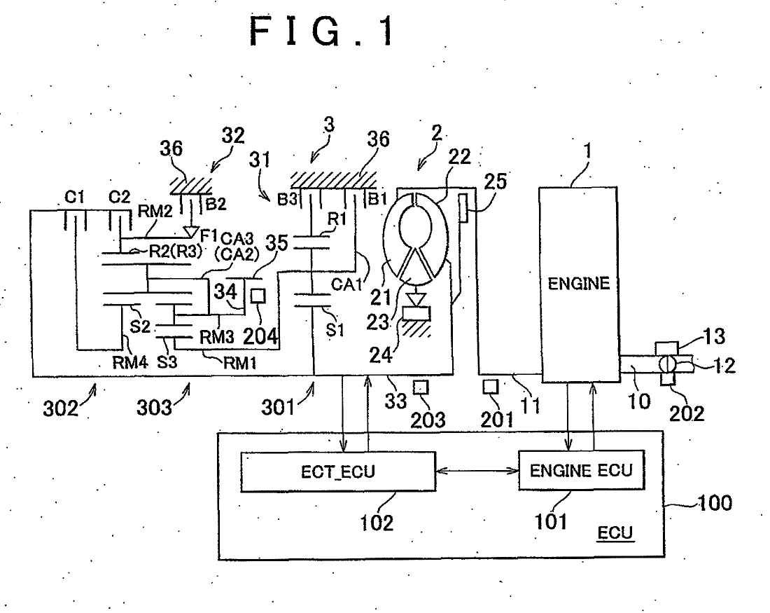

As shown in FIG. 1, a vehicle Z is equipped with an engine 1, a torque converter 2, an automatic transmission 3, and an ECU 100. Each of the engine 1, the torque converter 2, the automatic transmission 3 and the ECU 100 will be described below.

The engine 1 is, for example, a four-cylinder gasoline engine. A crankshaft 11 that is an output shaft of the engine 1 is connected to an input shaft of the torque converter 2. The rotation speed (engine rotation speed) of the crankshaft 11 is detected by an engine rotation speed sensor 201.

The intake air amount taken into the engine 1 is adjusted by a throttle valve 12 of an electronically controlled throttle system. The throttle valve 12 is capable of electronically controlling the degree of throttle opening independently of the accelerator pedal operation of a driver. The degree of throttle opening is detected by a throttle opening degree sensor 202.

The throttle opening degree of the throttle valve 12 is driven and controlled by the ECU 100. Concretely, the throttle opening degree of the throttle valve 12 is controlled so as to provide an optimum intake air amount (hereinafter, referred to as “target intake amount”) according to the operation state of the engine 1, such as the engine rotation speed detected by the engine rotation speed sensor 201, the accelerator operation amount as the driver's accelerator pedal depression amount, etc. More concretely, the actual throttle opening degree of the throttle valve 12 is detected via the throttle opening degree sensor 202, and a throttle motor 13 of the throttle valve 12 is feedback-controlled so that the actual throttle opening degree becomes equal to the throttle opening degree that provides the aforementioned target intake amount (which will be referred to as target throttle opening degree).

The torque converter 2 includes an input shaft-side pump impeller 21, an output shaft-side turbine runner 22, a stator 23 that realizes the torque amplification function, and a one-way clutch 24, and is designed to transmit power between the pump impeller 21 and the turbine runner 22 via a fluid.

The torque converter 2 is provided with a lockup clutch 25 that establishes a locked-up state between the input side and the output side. By fully engaging the lockup clutch 25 with the torque converter 2, the pump impeller 21 and the turbine runner 22 come to rotate integrally as one unit. Besides, if the lockup clutch 25 is engaged with the torque converter 2 in a predetermined slip state, the turbine runner 22 rotates following the pump impeller 21 with a predetermined slip amount during a driving (traction) state. Besides, the torque converter 2 and the automatic transmission 3 are interconnected by a rotating shaft.

The automatic transmission 3 is a transversely mounted type automatic transmission applied to an FF type vehicle. As shown in FIG. 1, the automatic transmission 3 is a planetary gear type multi-step transmission in which a first speed change portion 31 constructed mainly of a single-pinion type first planetary gear device 301, and a second speed change portion 32 constructed mainly of a single-pinion type second planetary gear device 302 and a double-pinion type third planetary gear device 303 are coaxially provided, and the rotation of an input shaft 33 is changed in speed, and then is transmitted to an output shaft 34, and is output from an output gear 35. The output gear 35 is linked directly or via a counter shaft to a differential gear device that is mounted in the vehicle. FIG. 1 omits a lower half construction of the automatic transmission 3 below the input shaft 33 which is substantially symmetric to the upper half construction shown.

The first planetary gear device 301 constituting the first speed change portion 31 includes three rotating elements, that is, a sun gear S1, a carrier CA1, and a ring gear R1. The sun gear S1 is linked to the input shaft 33. The sun gear S1 comes to rotate with the carrier CA1 serving as an intermediate output member, when the ring gear R1 is fixed to a housing 36 via a third brake B3.

The second planetary gear device 302 and the third planetary gear device 303 constituting the second speed change portion 32 are partially linked to each other so that four rotating element RM1 to RM4 are formed. Concretely, a sun gear S3 of the third planetary gear device 303 constitutes a first rotating element RM1, and a ring gear R2 of the second planetary gear device 302 and a ring gear R3 of the third planetary gear device 303 are interlinked so as to constitute a second rotating element RM2. Furthermore, a carrier CA2 of the second planetary gear device 302 and a carrier CA3 of the third planetary gear device 303 are interlinked so as to constitute a third rotating element RM3. Besides, a sun gear S2 of the second planetary gear device 302 constitutes a fourth rotating element RM4.

In the second planetary gear device 302 and the third planetary gear device 303, the carriers CA2 and CA3 are formed by a member common to the two devices, and the ring gears R2 and R3 are also formed by a member common to the two devices. Furthermore, the second planetary gear device 302 and the third planetary gear device 303 form a Ravigneaux type planetary gear train in which the pinions of the second planetary gear device 302 serve also as the second pinions of the third planetary gear device 303.

The first rotating element RM1 (sun gear S3) is integrally linked to the carrier CA1 of the first planetary gear device 301, that is, an intermediate output member, and is rotated and stopped by selectively linking it to the housing 36 via the first brake B1. The second rotating element RM2 (ring gears R2 and R3) is rotated and stopped by selectively linking it to the input shaft 33 via a second clutch C2, or by selectively linking it to the housing 36 via a one-way clutch F1 and a second brake B2.

The third rotating element RM3 (carriers CA2 and CA3) is integrally linked to the output shaft 34. The fourth rotating element RM4 (sun gear S2) is selectively linked to the input shaft 33 via a first clutch C1.

Incidentally, the first clutch C1 the second clutch C2, the first brake B1, the second brake B2 the third brake B3 are all multi-disc hydraulic type friction engagement elements that are frictionally engaged by hydraulic cylinders.

The automatic transmission 3 as described above sets gearshift positions as the first clutch C1, the second clutch C2, the first brake B1, the second brake B2, the third brake B3, the one-way clutch F1, etc., which are friction engagement elements, are engaged or released into predetermined states.

The automatic transmission 3 is provided with a shift lever that is operated by a driver. By operating the shift lever, the shift position can be switched among, for example, the P range (parking range), the R range (reverse travel range), the N (neutral range), the D range (forward travel range), etc.

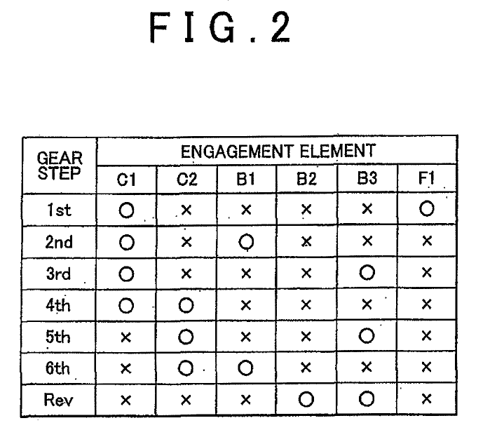

FIG. 2 is an engagement table illustrating the engagement actions of the clutches C1 and C2, the brakes B1 to B3 and the one-way clutch F1 for establishing the gearshift positions of the automatic transmission 3 in accordance with the embodiment of the invention. In the table, the circles and the crosses represent engagement and release, respectively.

As shown in FIG. 2, a first gearshift position (1st) is established by engaging the first clutch C1 in the automatic transmission 3.

The shift (1st→2nd) from the first gearshift position (1st) to the second gearshift position (2nd) is accomplished by engaging the first brake B1.

The shift (2nd→3rd) from the second gearshift position (2nd) to the third gearshift position (3rd) is accomplished by releasing the first brake B1 and engaging the third brake B3.

The shift (3rd→4th) from the third gearshift position (3rd) to the fourth gearshift position (4th) is accomplished by releasing the third brake B3 and engaging the second clutch C2.

The shift (4th→5th) from the fourth gearshift position (4th) to the fifth gearshift position (5th) is accomplished by releasing the first clutch C1 and engaging the third brake B3.

The shift (5th→6th) from the fifth gearshift position (5th) to the sixth gearshift position (6th) is accomplished by releasing the third brake B3 and engaging the first brake B1.

The reverse gearshift position (Rev) is established by engaging the second brake B2 and the third brake B3.

The gear ratio of each gearshift position of the automatic transmission 3 is appropriately determined by the gear ratio (=the number of teeth of the sun gear/the number of teeth of the ring gear) of each of the first planetary gear device 301, the second planetary gear device 302 and the third planetary gear device 303.

The rotation speed of the input shaft 33 of the automatic transmission 3 is detected by an input shaft rotation speed sensor 203. Besides, the rotation speed of the output shaft 34 of the automatic transmission 3 is detected by an output shaft rotation speed sensor 204. On the basis of the ratio between the rotation speeds obtained from the output signals of the input shaft rotation speed sensor 203 and the output shaft rotation speed sensor 204 (output rotation speed/input rotation speed), the actual gearshift position of the automatic transmission 3 can be determined.

The ECU 100 that controls the above-described vehicular power train includes an engine ECU 101 that controls the engine 1, and an ECT_ECU (Electronic Controlled automatic Transmission_ECU) 102 that controls the torque converter 2 and the automatic transmission 3.

The engine ECU 101 and the ECT_ECU 102 each includes a CPU, a ROM, a RAM, a backup RAM, etc.

In each of the ECUs, the ROM stores various control programs, maps that are referred to when the control programs are executed, etc. The CPU executes computation processes on the basis of the control programs and the maps stored in the ROM. The RAM is a memory that temporarily stores computation results provided by the CPU, the data input from various sensors, etc. The backup RAM is a non-volatile memory that stores data and the like that need to be retained during stop of the engine 1.

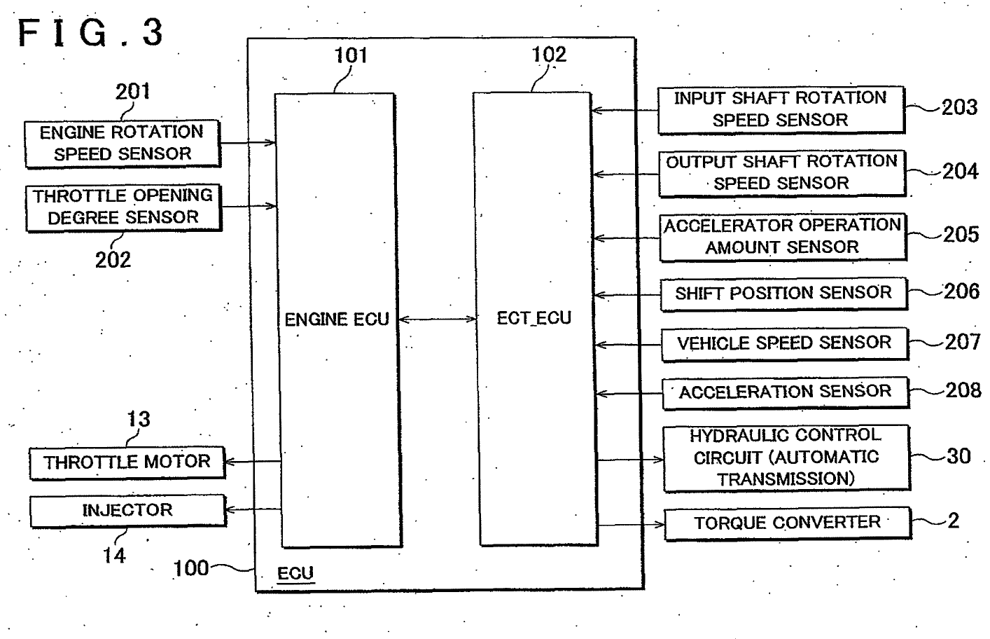

As shown in FIG. 3, various sensors that detect operation states of the engine 1, including the engine rotation speed sensor 201, the throttle opening degree sensor 202, etc., are connected to the engine ECU 101. Signals from the various sensors are input to the engine ECU 101. The engine ECU 101 also controls various portions of the engine 1, such as the throttle motor 13 of the throttle valve 12, an injector 14, etc.

Various sensors are connected to the ECT_ECU 102 as shown in FIG. 3, including the input shaft rotation speed sensor 203, the output shaft rotation speed sensor 204, an accelerator operation amount sensor 205 that detects the degree of depression of the accelerator pedal operated by a driver, a shift position sensor 206 that detects the shift lever position of the automatic transmission 3, a vehicle speed sensor 207 that detects the speed of the vehicle, an acceleration sensor 208 that detects the acceleration of the vehicle, etc.

The ECT_ECU 102 outputs a lockup clutch control signal to the torque converter 2. On the basis of the lockup clutch control signal, the engagement pressure of the lockup clutch 25 is controlled. Furthermore, the ECT_ECU 102 outputs a solenoid control signal (oil pressure command signal) to the hydraulic control circuit 30 of the automatic transmission 3. On the basis of the solenoid control signal, linear solenoid valves, on-off solenoid valves, etc., of the hydraulic control circuit 30 are controlled, and the first clutch C1, the second clutch C2, the first brake B1, the second brake B2, the third brake B3, the one-way clutch F1 of the automatic transmission 3, etc., are released or engaged into predetermined states so as to achieve a predetermined gearshift position (the first gearshift position to the sixth gearshift position, the reverse gearshift position, etc.).

The engine ECU 101 sends the signals representing the throttle opening degree detected by the throttle opening degree sensor 202, the engine rotation speed detected by the engine rotation speed sensor 201 as well as a downshift request and the like to the ECT_ECU 102. On the other hand, the ECT_ECU 102 sends to the engine ECU 101 the signals representing the input shaft rotation speed detected by the input shaft rotation speed sensor 203, the output rotation speed detected by the output shaft rotation speed sensor 204, the accelerator operation amount detected by the accelerator operation amount sensor 205, etc.

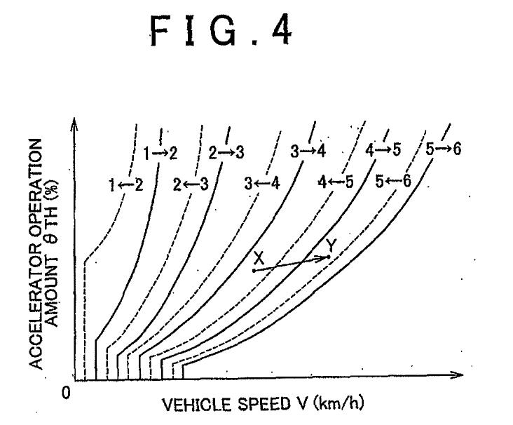

The shift control of the automatic transmission 3 is performed, for example, following a shift map (shift condition) as shown in FIG. 4. The shift map is a map in which a plurality of regions for finding a proper gearshift position according to the vehicle speed V and the accelerator operation amount θTH are set by using the vehicle speed V and the accelerator operation amount θTH as parameters. The shift map is stored in the ROM. The regions in the shift map are partitioned by a plurality of shift lines (switch lines between gearshift positions). In the shift map shown in FIG. 4, upshift lines (shift lines) are shown by solid lines, and downshift lines (shift lines) are shown by interrupted lines. Besides, the switching directions of the upshifts and the downshifts are shown in FIG. 4 by using numerals and arrows.

Next, a basic operation of the shift control of the automatic transmission 3 constructed as described above will be described.

The ECT_ECU 102 calculates the vehicle speed V from the output signal of the vehicle speed sensor 207, and calculates the accelerator operation amount from the output signal of the accelerator operation amount sensor 205, and calculates a target gearshift position by referring to the shift map of FIG. 4 on the basis of the calculated vehicle speed V and the calculated accelerator operation amount θTH. Furthermore, the ECT_ECU 102 determines actual gearshift position by finding the ratio of the rotation speeds obtained from the output signals of the input shaft rotation speed sensor 203 and the output shaft rotation speed sensor 204 (output rotation speed/input rotation speed), and determines whether or not a shift operation is needed, by comparing the actual gearshift position and the target gearshift position.

In the case where a result of the determination is that the shift is not needed (the case where the actual gearshift position is equal to the target gearshift position, and therefore the gearshift position is appropriately set), the ECT_ECU 102 outputs a solenoid control signal (oil pressure command signal) for maintaining the actual gearshift position to the hydraulic control circuit 30 of the automatic transmission 3.

On the other hand, in the case where the actual gearshift position is different from the target gearshift position, the ECT_ECU 102 performs the shift control. For example, in the case where from a situation in which the vehicle is traveling while the gearshift position of the automatic transmission 3 is the “4th speed”, the traveling state of the vehicle changes so that, for example, a change from a point X to a point Y in FIG. 4 occurs, the change crosses the upshift shift line “4→5”, and therefore, the target gearshift position calculated from the shift map becomes the “5th speed”. Then, the ECT_ECU 102 outputs a solenoid control signal (oil pressure command signal) for setting the fifth gearshift position to the hydraulic control circuit 30 of the automatic transmission 3, so that the shift from the fourth gearshift position to the fifth gearshift position (4→5 upshift) is performed.

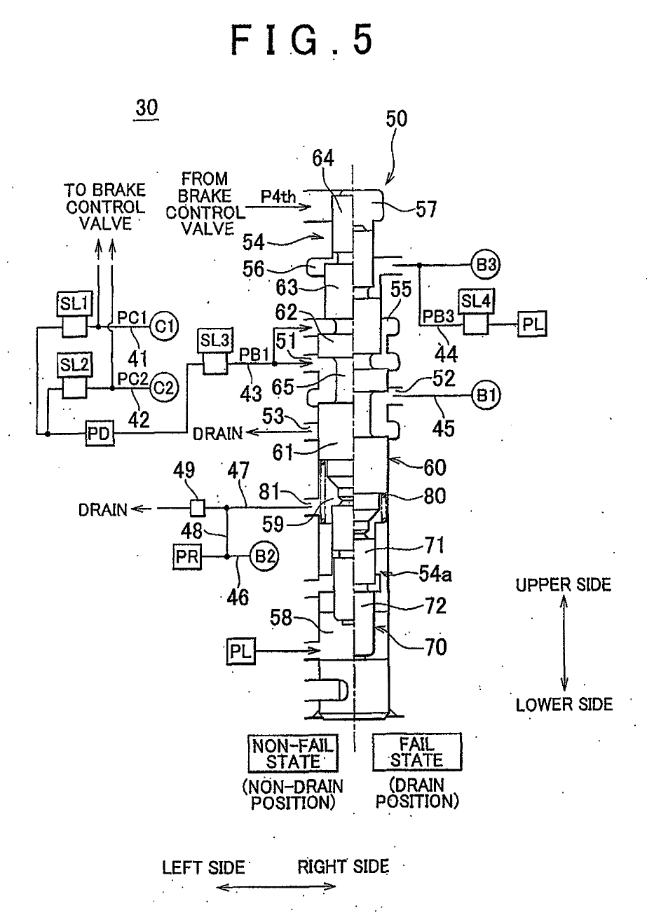

Next, with reference to FIG. 5, the constructions of a fail-safe valve that is a feature portion of the embodiment and its peripheral portion of the hydraulic control circuit 30 will be described. FIG. 5 shows portions of the hydraulic control circuit 30 that are related to a clutch apply control valve 50 as a fail-safe valve, the first and second clutches C1, C2, the first to third brake B1, B2, B3. Incidentally, the hydraulic control circuit 30 shown in FIG. 5 is a portion of the entire hydraulic control circuit. The construction of the hydraulic control circuit 30 will be concretely described below.

The hydraulic control circuit 30 includes a first electromagnetic valve SL1 for controlling the first clutch C1, a second electromagnetic valve SL2 for controlling the second clutch C2, a third electromagnetic valve SL3 for controlling the first brake B1, and a fourth electromagnetic valve SL4 for controlling the third brake B3.

The hydraulic control circuit 30 further includes a brake control valve (not shown). This brake control valve is constructed to drain the working oil pressure of the third brake B3 and output a predetermined fourth-speed oil pressure P4th (gearshift position: from the third speed to the fourth speed) in a situation where an oil pressure PC1 for engaging the first clutch C1 and an oil pressure PC2 for engaging the second clutch C2 are both supplied. Since the construction of the brake control valve is well known, the description of details of the construction is omitted.

The hydraulic control circuit 30 includes the clutch apply control valve (fail-safe valve) 50. This clutch apply control valve 50 is constructed to drain the working oil pressure of the first brake B1 in the case where at least two of the fourth-speed oil pressure P4th supplied from the brake control valve, an oil pressure PB1 for engaging the first brake B1, and an oil pressure PB3 for engaging the third brake B3 are supplied. Details of this construction will be described below.

Each of the first to fourth electromagnetic valves SL1, SL2, SL3, SL4 is a linear solenoid valve that generates a predetermined oil pressure according to the drive current supplied from the ECT_ECU 102.

The first electromagnetic valve SL1 generates the first oil pressure PC1 for directly controlling the state of engagement of the first clutch C1 by using as a basic pressure the D range pressure PD output from a manual valve (not shown), and outputs the first oil pressure PC1 to a first oil passageway 41 that connects to the first clutch C 1.

The second electromagnetic valve SL2 generates a second oil pressure PC2 for directly controlling the state of engagement of the second clutch C2 by using the D range pressure PD as a basic pressure, and outputs the second oil pressure PC2 to a second oil passageway 42 that connects to the second clutch C2.

The third electromagnetic valve SL3 generates a third oil pressure PB1 for controlling the state of engagement of the first brake B1 by using the D range pressure PD as a basic pressure, and outputs the third oil pressure PB1 to a third oil passageway 43 that connects to the clutch apply control valve 50.

The fourth electromagnetic valve SL4 generates a fourth oil pressure PB3 for directly controlling the state of engagement of the third brake B3 by using the line pressure PL as a basic pressure, and outputs the fourth oil pressure PB3 to a fourth oil passageway 44 that connects to the third brake B3.

The clutch apply control valve 50 has a first input port 51 for inputting the third oil pressure PB1 from the third electromagnetic valve SL3, a first output port 52 for supplying the third oil pressure PB1 input to the first input port 51 to the first brake B1 via the fifth oil passageway 45, and a first drain port 53 for draining the third oil pressure PB1 supplied to the first brake B1 via the fifth oil passageway 45.

In the clutch apply control valve 50, a valve element 60 and a plunger (first valve unit) 70 are housed so as to be freely movable along the same axis within a valve body 54.

The valve element 60 has a construction in which a first land 61 and a second land 62 that have a predetermined section area (a section area orthogonal to the center axis) SA, a third land 63 having a section area SB smaller than the section area SA of the first land 61 and the second land 62, and a fourth land 64 having a section area SC smaller than the section area SB of the third land 63 are integrally formed.

The valve element 60 has a valve portion 65 that is arranged so as to be movable between a drain position (as shown by the right-side half of the illustration of the clutch apply control valve 50 in FIG. 5) in which the first output port 52 and the first drain port 53 are connected to communicate with each other so as to drain the oil pressure of the first brake B1, and a non-drain position (as shown by the left-side half of the illustration of the clutch apply control valve 50 in FIG. 5) in which the first input port 51 and the first output port 52 are connected to communicate with each other.

Between the valve body 54 and the valve element 60, there are formed a first oil chamber 55 that receives the third oil pressure PB1 output from the third electromagnetic valve SL3, and that generates a thrust on the valve element 60 in the direction to the drain position on the basis of the difference in section area between the second land 62 and the third land 63, and a second oil chamber 56 that receives the fourth oil pressure PB3 output from the fourth electromagnetic valve SL4, and that generates a thrust on the valve element 60 in the direction to the drain position by causing the fourth oil pressure PB3 to act on an end surface of the third land 63. Furthermore, between the valve body 54 and the valve element 60, there is formed a third oil chamber 57 that receives the fourth-speed oil pressure P4th output from the brake control valve, and that generates a thrust on the valve element 60 in the direction to the drain position by causing the fourth-speed oil pressure P4th to act on a distal end surface of the fourth land 64.

Furthermore, between the valve body 54 and the plunger 70, there is formed a fourth oil chamber (line pressure oil chamber) 58 that receives the line pressure PL, and that generates a thrust on the valve element 60 via the plunger 70 in the direction to the non-drain position by causing the line pressure PL to act on a distal end surface (an end surface opposite to the position where the valve element 60 is disposed, that is, a lower end surface in FIG. 5).

Still further, between the valve element 60 and the plunger 70, there is formed a fifth oil chamber (extraneous matter-discharging oil chamber) 59 that communicates with a second drain port 81 that becomes a drain port during a state in which a forward vehicle travel-side gearshift position (any one of the first to sixth gearshift positions) is established.

Then, the fifth oil chamber 59 houses a spring 80 that urges the valve element 60 toward the non-drain position. Concretely, a sleeve 54a is attached to an outer peripheral side of the plunger 70 within the valve body 54. A spring 80 in a compressed state is housed between an upper end surface of the sleeve 54a and a lower end surface of the first land 61 of the valve element 60.

Due to the foregoing construction, during a state of the clutch apply control valve 50 in which the input of at least two oil pressures of the third oil pressure PB1, the fourth oil pressure PB3, and the fourth-speed oil pressure P4th from the brake control valve is not given and the following mathematical expression (1) is satisfied, the valve element 60 and the plunger 70 are moved to the non-drain position by the line pressure PL (that is generated when the engine 1 is driven) acting in the fourth oil chamber 58 and the urging force of the spring 80 (that acts during stop of the engine 1 as well). Therefore, in a situation in which the third oil pressure PB1 is output from the third electromagnetic valve SL3 (when the second gearshift position or the sixth gearshift position is established), the third oil pressure PB1 is supplied to the first brake B1 via the fifth oil passageway 45.

On the other hand, during a state in which at least two oil pressures of the third oil pressure PB1, the fourth oil pressure PB3, and the fourth-speed oil pressure P4th from the brake control valve are input and the following mathematical expression (2) is satisfied, the input oil pressures overcome the line pressure PL acting in the fourth oil chamber 58 and the urging force of the spring 80, so that the valve element 60 and the plunger 70 are moved to the drain position and the oil pressure of the first brake B1 and the fifth oil passageway 45 is drained from the first drain port 53.

In the mathematical expressions (1) and (2) below, the urging force of the spring 80 is represented by FV2. Besides, SD represents the pressure receiving area of the lower end of the plunger 70.

(SB−SA)×PB1+(SC−SB)×PB3+SC×P4th<SD×PL+FV2 (1)

(SB−SA)×PB1+(SC−SB)×PB3+SC×P4th>SD×PL+FV2 (2)

Thus, even in the case where such an engagement state that interlocking may occur during a forward travel has occurred, the automatic transmission 3 is able to drain a portion of the oil pressure and avoid the interlocking, due to the provision of the brake control valve and the clutch apply control valve 50.

A feature of this embodiment is the construction for causing the clutch apply control valve 50 constructed as described above to perform the extraneous matter discharge at predetermined timing. That is, the feature is the construction for avoiding the occurrence of the valve sticking (fixture between the valve body 54 and the plunger 70) caused by very small extraneous matter accumulating between the valve body 54 and the plunger 70 when the switching operation of the clutch apply control valve 50 is not performed over a long period of time. Incidentally, although the following description will be made in conjunction with the case where the foregoing matter discharge is performed when the automatic transmission 3 is set to the reverse gearshift position, the gearshift position that involves the extraneous matter discharge is not limited to the reverse gearshift position, but the extraneous matter discharge may also be performed when one of the forward-travel gearshift positions (e.g., the first gearshift position) is set.

This embodiment has features in the construction of an oil passageway that connects to the second drain port 81 that communicates with the fifth oil chamber 59, and the shape of the plunger 70. Hereinafter, the features will be concretely described.

There is provided a sixth oil passageway 46 for causing the reverse range pressure PR to act on the second brake B2 in the case where the shift lever is operated to the R range (reverse travel range) position and the reverse range pressure PR is produced from the manual valve.

A drain oil passageway 47 is connected to communicate with the second drain port 81 so as to drain the oil pressure of the fifth oil chamber 59 when the automatic transmission 3 is at a forward-travel gearshift position (one of the first to sixth gearshift positions).

The sixth oil passageway 46 and the drain oil passageway 47 are connected to communicate with each other via a reverse range pressure branch oil passageway 48. Besides, a valve unit 49 (e.g., an electromagnetic valve) as a second valve unit capable of being freely opened and closed is provided on the drain oil passageway 47 extending on a drain side (oil pan side) of the position of the connection with the reverse range pressure branch oil passageway 48. The opening/closing operation of the valve unit 49 is performed by a drive current supplied from the ECT_ECU 102.

Therefore, in the case where the reverse range pressure PR is produced from the manual valve during a closed state of the valve unit 49, the reverse range pressure PR is supplied to the second brake B2, so that the second brake B2 is engaged; moreover, the reverse range pressure PR is also supplied through the reverse range pressure branch oil passageway 48 and the drain oil passageway 47 to the second drain port 81, and therefrom to the fifth oil chamber 59. That is, the reverse range pressure PR acts on the upper end surface of the plunger 70 (an end surface thereof that faces the valve element 60). Incidentally, the construction for supplying oil pressure through the drain oil passageway 47 to the second drain port 81 and therefore causing the oil pressure to act in the fifth oil chamber 59 is not limited to the construction that employs the valve unit 49.

The plunger 70 has a construction in which a plunger first land 71 located at the valve element 60 side (an upper side in FIG. 5) and a plunger second land 72 located the fourth oil chamber 58 side (a lower side in FIG. 5) are integrally formed.

The plunger first land 71 is in contact with the first land 61 of the valve element 60 not only when at the non-drain position, but also when at the drain position. That is, during an ordinary state of the automatic transmission 3 (where a fail is not present), the valve element 60 is moved to an upper side in FIG. 5 and the plunger 70 is pushed upward by the line pressure PL acting in the fourth oil chamber 58. On the other hand, when the automatic transmission 3 has a fail, at least two of the third oil pressure PB1, the fourth oil pressure PB3 and the fourth-speed oil pressure P4th are supplied, and the pressing force on the valve element 60 caused by these oil pressures overcomes the pressing pressure caused by the line pressure PL and the like, so that the plunger 70 is moved together with the valve element 60 to a lower side in FIG. 5.

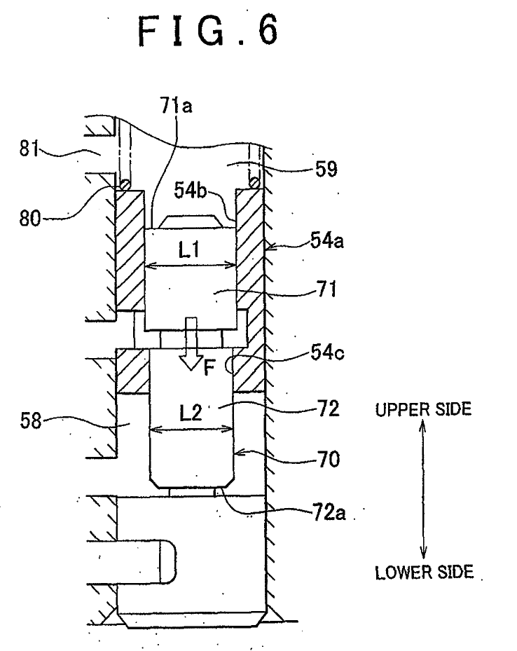

Then, as shown in FIG. 6, the outside diameter (L1) of the plunger first land 71 is set larger than (e.g., about 1.2 times as large as) the outside diameter (L2) of the plunger second land 72. That is, in this plunger 70, the pressure receiving area of the upper surface 71a of the plunger first land 71 (the area that receives the oil pressure of the fifth oil chamber 59) is set larger than the pressure receiving area of the lower surface 72a of the plunger second land 72 (the area that receives the oil pressure of the fourth oil chamber 58). Therefore, when the oil pressure of the fifth oil chamber 59 and the oil pressure of the fourth oil chamber 58 are substantially equal, a thrust in the direction of an arrow F in FIG. 6 (downward direction) occurs on the plunger 70, and the plunger 70 moves to the lower side.

Incidentally, as for the inside diameter of the sleeve 54a attached within the valve body 54, the inside diameter of a portion thereof that is in sliding contact with the outer peripheral surface of the plunger first land 71 is substantially equal to the outside diameter (L1) of the plunger first land 71, and the inside diameter of a portion thereof that is in sliding contact with the outer peripheral surface of the plunger second land 72 is substantially equal to the outside diameter (L2) of the plunger second land 72. In other words, the sleeve 54a has a large-diameter portion 54b that corresponds to the plunger first land 71, and a small-diameter portion 54c that corresponds to the plunger second land 72.

Next, the extraneous matter discharge by the clutch apply control valve 50 constructed as described above will be described. The extraneous matter discharge is an operation of moving the plunger 70 (to the lower side in FIG. 5) only when the shift lever is operated to the R range position and therefore the reverse range pressure PR is produced from the manual valve during the ordinary state of the automatic transmission 3 (i.e., a normal operation, which will be hereinafter referred to as “non-failure state”). By this operation, extraneous matter present between the plunger 70 and the valve body 54 (more concretely, the sleeve 54a) can be discharged. Hereinafter, concrete operations will be described.

As described above, in the case where the automatic transmission 3 is at a forward-travel gearshift position (one of the first to sixth gearshift positions) during the non-failure state of the automatic transmission 3, the valve element 60 and the plunger 70 are at the non-drain position (the position indicated by the left-side half of the illustration thereof in FIG. 5).

If, from this state, the shift lever is operated to the R range position and therefore the reverse range pressure PR is produced from the manual valve, the reverse range pressure PR is supplied to the second brake B2 via the sixth oil passageway 46, so that the reverse gearshift position (Rev) is established (simultaneously, the fourth electromagnetic valve SL4 is also actuated to produce the fourth oil pressure PB3, so that the third brake B3 is engaged). Besides, substantially simultaneously with this operation, the valve unit 49 is closed, so that the reverse range pressure PR is also supplied through the reverse range pressure branch oil passageway 48 and the drain oil passageway 47 to the second drain port 81 and then to the fifth oil chamber 59. It is to be noted herein that the reverse range pressure PR supplied to the fifth oil chamber 59 is substantially equal to the line pressure PL.

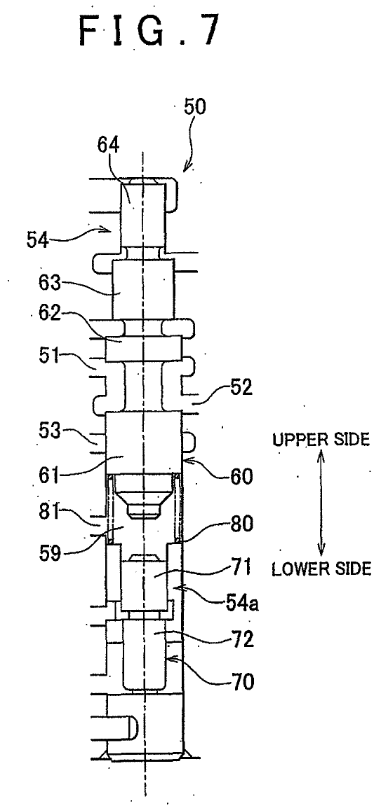

As described above, the outside diameter of the plunger first land 71 is larger than the outside diameter of the plunger second land 72. That is, the plunger 70 is constructed so that the pressure receiving area of the plunger first land 71 (the area that receives the oil pressure of the fifth oil chamber 59) is larger than the pressure receiving area of the plunger second land 72 (the area that receives the oil pressure of the fourth oil chamber 58). Therefore, as the oil pressure of the fifth oil chamber 59 (reverse range pressure PR) and the oil pressure of the fourth oil chamber 58 (line pressure PL) act together on the plunger 70, the plunger 70 receives a thrust in the direction of an arrow F in FIG. 6 due to the difference in the pressure receiving area. As a result, the plunger 70 moves to the lower side in FIG. 6 (to the drain position side, which is the side opposite from the location where the valve element 60 is disposed). That is, by using the reverse range pressure PR as an extraneous matter-discharging oil pressure, the plunger 70 is caused to perform the extraneous matter discharge. FIG. 7 shows a state in which the plunger 70 has moved to the lower side.

Due to the foregoing operation, if very small extraneous matter, such as abrasion powder, sludge, etc., is present between the plunger 70 and the valve body 54 (sleeve 54a), the very small extraneous matter is removed as the plunger 70 moves. The foregoing operation is executed every time the reverse travel gear step of the automatic transmission 3 is established.

Then, the very small extraneous matter discharged into the fourth oil chamber 58 along with the movement of the plunger 70 is collected toward an oil filter (not shown) or the like as the line pressure PL is removed (the line pressure PL is drained) in association with stop of the engine or the like.

According to this embodiment, since the extraneous matter discharge as described above is performed, the problem of valve sticking caused by the plunger 70 of the clutch apply control valve 50 remaining unmoved for a long period of time can be resolved. Besides, since such a member as a spring or the like is not used as means for moving the plunger 70 to perform the extraneous matter discharge, there is no need to add a component part (e.g., an inside spring disclosed in JP-A-2004-036670) to the clutch apply control valve. Therefore, size increase and weight increase of the clutch apply control valve 50 can be prevented, and the rise in production cost can be curbed. Furthermore, increase in the assembly man-hours and complication of the assembly operation can be prevented.

Although the foregoing embodiment, the invention is applied to the automatic transmission 3 with the six-forward gear speeds, the invention is not limited so, but is also applicable to automatic transmissions with any other number of gearshift positions or any other arrangement or the like thereof.

Furthermore, although in the embodiment, the shift control is executed by finding a proper gearshift position on the basis of the vehicle speed and the accelerator operation amount, the invention is not limited so, but may also be applied to a construction in which the shift control is executed by finding a proper gearshift position on the basis of the vehicle speed and the throttle opening degree.

The engine mounted in the vehicle to which the invention is applied is not limited to a gasoline engine, but may also be a diesel engine or the like.

Furthermore, in the foregoing embodiment, the invention is applied to the automatic transmission 3 that is mounted in the FF vehicle. However, the invention is not limited so, but is also applicable to the automatic transmission mounted in an FR vehicle or other forms of vehicles.

Still further, although in the embodiment, the invention is applied to the clutch apply control valve 50 as a fail-safe valve, the invention is not limited so, but can also be applied to other fail-safe valves in the hydraulic control circuit 30 (e.g., the aforementioned brake control valve, or the like).

Still further, although in the embodiment, only the plunger 70 is moved at the time of the extraneous matter discharge, it also becomes possible to move the valve element 60 at the time of the extraneous matter discharge if a circuit construction in which the reverse range pressure PR acts on the valve element 60 to the drain position side is provided.

Yet further, although in the foregoing description of the embodiment, the line pressure PL and the reverse range pressure PR are presented as examples of the oil pressures that act on the plunger 70 at the time of the extraneous matter discharge, the invention is not limited by those presented oil pressures, but any other oil pressure may be used as long as the oil pressure can cause a movement of the plunger 70 (the extraneous matter discharge).

While the invention has been described with reference to example embodiments thereof it should be understood that the invention is not limited to the example embodiments or constructions. To the contrary, the invention is intended to cover various modifications and equivalent arrangements. In addition, while the various elements of the example embodiments are shown in various combinations and configurations, which are example, other combinations and configurations, including more, less or only a single element, are also within the spirit and scope of the invention.

1. An automatic transmission fail-safe mechanism which is provided in a hydraulic control circuit of an automatic transmission that changes gear ratio by controlling oil pressure with respect to a plurality of friction engagement elements to selectively engage the plurality of friction engagement elements, and which has a fail-safe valve whose first valve unit moves from a non-failure position to a failure position when the automatic transmission is under failure,
wherein when a predetermined gearshift is positioned in the automatic transmission during a non-failure state of the automatic transmission, the fail-safe mechanism of the automatic transmission causes the first valve unit to move from the non-failure position toward the failure position by causing the oil pressure for positioning the predetermined gearshift to act on the fail-safe valve as an extraneous matter-discharging oil pressure, and
wherein:
a valve element and the first valve unit are coaxially inserted so as to be movable relative to each other within a valve body of the fail-safe valve;
an extraneous matter-discharging oil chamber is provided between the valve element and the first valve unit;
a line pressure oil chamber in which a line pressure of the hydraulic control circuit acts is provided between the first valve unit and the valve body;
a pressure receiving area of an end surface of the first valve unit that faces the extraneous matter-discharging oil chamber is set larger than a pressure receiving area of an end surface of the first valve unit that faces the line pressure oil chamber; and
an oil pressure that is substantially equal to the line pressure acts in the extraneous matter-discharging oil chamber if the predetermined gearshift is positioned during the non-failure state of the automatic transmission.

2. The automatic transmission fail-safe mechanism according to claim 1, wherein the predetermined gearshift being positioned when the first valve unit moves from the non-failure position toward the failure position is a reverse gearshift.

3. (canceled)

4. The automatic transmission fail-safe mechanism according to claim 1, further comprising:
a first oil passageway as a supply oil passageway of the oil pressure for positioning the predetermined gearshift;
a second oil passageway as a drain oil passageway;
a branch oil passageway that connects the first oil passageway and the second oil passageway in communication; and
a second valve unit provided in the second oil passageway at a drain side of a connecting position between the second oil passageway and the branch oil passageway,
wherein if the predetermined gearshift is positioned during the non-failure state of the automatic transmission, the oil pressure for positioning the predetermined gearshift is supplied via the branch oil passageway to the extraneous matter-discharging oil chamber by closing the second valve unit, so that the oil pressure acts on the fail-safe valve as the extraneous matter-discharging oil pressure.

5. The automatic transmission fail-safe mechanism according to claim 1, wherein the valve element and the first valve unit are in contact with each other, when the predetermined gearshift is positioned in the automatic transmission during the non-failure state of the automatic transmission, the valve element moves together with the first valve unit from the non-failure position toward the failure position.

6. An automatic transmission fail-safe mechanism which is provided in a hydraulic control circuit of an automatic transmission that changes gear ratio by controlling oil pressure with respect to a plurality of friction engagement elements to selectively engage the plurality of friction engagement elements, and which has a fail-safe valve whose first valve unit moves from a non-failure position to a failure position when the automatic transmission is under failure,
wherein when a predetermined friction engagement element of the plurality of friction engagement elements is engaged during a non-failure state of the automatic transmission, the fail-safe mechanism of the automatic transmission causes the first valve unit to move from the non-failure position toward the failure position by causing the oil pressure for engaging the predetermined friction engagement element to act on the fail-safe valve as an extraneous matter-discharging oil pressure, and
wherein:
a valve element and the first valve unit are coaxially inserted so as to be movable relative to each other within a valve body of the fail-safe valve;
an extraneous matter-discharging oil chamber is provided between the valve element and the first valve unit;
a line pressure oil chamber in which a line pressure of the hydraulic control circuit acts is provided between the first valve unit and the valve body;
a pressure receiving area of an end surface of the first valve unit that faces the extraneous matter-discharging oil chamber is set larger than a pressure receiving area of an end surface of the first valve unit that faces the line pressure oil chamber; and
an oil pressure substantially equal to the line pressure acts in the extraneous matter-discharging oil chamber if the predetermined friction engagement element is engaged during the non-failure state of the automatic transmission.

7. The automatic transmission fail-safe mechanism according to claim 6, wherein the predetermined friction engagement element being engaged when the first valve unit moves from the non-failure position toward the failure position is a friction engagement element that is not engaged if a forward travel gearshift of the automatic transmission is positioned, and that is engaged if a reverse gearshift of the automatic transmission is positioned.

8. An automatic transmission fail-safe mechanism which is provided in a hydraulic control circuit of an automatic transmission that changes gear ratio by controlling oil pressure with respect to a plurality of friction engagement elements to selectively engage the plurality of friction engagement elements, and which has a fail-safe valve whose first valve unit is moved from a non-failure position to a failure position by a plurality of oil pressures that do not simultaneously occur during the non-failure state of the automatic transmission as the plurality of oil pressures act from individual oil pressure supply ports, characterized in that
when a predetermined friction engagement element of the plurality of friction engagement elements is engaged during the non-failure state of the automatic transmission, the fail-safe mechanism of the automatic transmission causes the first valve unit to move from the non-failure position toward the failure position by causing the oil pressure for engaging the predetermined friction engagement element to act on the fail-safe valve from a drain port as an extraneous matter-discharging oil pressure.

9. The automatic transmission fail-safe mechanism according to claim 8, wherein the drain port is provided for draining oil when the vehicle is traveling forward, and if the oil pressure for engaging the predetermined friction engagement element acts on the fail-safe valve from the drain port when the vehicle reversely moves, the first valve unit moves from the non-failure position toward the failure position.

10. The automatic transmission fail-safe mechanism according to claim 8, wherein the drain port communicates with an extraneous matter-discharging oil chamber that is provided between the valve element and a first valve unit.

11. The automatic transmission fail-safe mechanism according to claim 8, wherein:
a valve element and the first valve unit are coaxially inserted so as to be movable relative to each other within a valve body of the fail-safe valve;
an extraneous matter-discharging oil chamber is provided between the valve element and the first valve unit;
a line pressure oil chamber in which a line pressure of the hydraulic control circuit acts is provided between the first valve unit and the valve body;
a pressure receiving area of an end surface of the first valve unit that faces the extraneous matter-discharging oil chamber is set larger than a pressure receiving area of an end surface of the first valve unit that faces the line pressure oil chamber; and
an oil pressure substantially equal to the line pressure acts in the extraneous matter-discharging oil chamber if the predetermined friction engagement element is engaged during the non-failure state of the automatic transmission.

12. The automatic transmission fail-safe mechanism according to claim 6, further comprising:
a first oil passageway as a supply oil passageway of the oil pressure for positioning the predetermined gearshift;
a second oil passageway as a drain oil passageway;
a branch oil passageway that connects the first oil passageway and the second oil passageway in communication; and
a second valve unit provided in the second oil passageway at a drain side of a connecting position between the second oil passageway and the branch oil passageway,
wherein if the predetermined friction engagement element is engaged during the non-failure state of the automatic transmission, the oil pressure for engaging the predetermined friction engagement element is supplied via the branch oil passageway to the extraneous matter-discharging oil chamber by closing the second valve unit, so that the oil pressure acts on the fail-safe valve as the extraneous matter-discharging oil pressure.

13. The automatic transmission fail-safe mechanism according to claim 6, wherein the valve element and the first valve unit are in contact with each other, and when a predetermined friction engagement element of the plurality of friction engagement elements is engaged during the non-failure state of the automatic transmission, the valve element moves together with the first valve unit from the non-failure position toward the failure position.

14. The automatic transmission fail-safe mechanism according to claim 1, wherein an outside diameter of a pressure receiving area of an end surface of the first valve unit that faces the extraneous matter-discharging oil chamber is set approximately 1.2 times as large as an outside diameter of a pressure receiving area of an end surface of the first valve unit that faces the line pressure oil chamber.

15. The automatic transmission fail-safe mechanism according to claim 1, wherein in the first valve unit, a first land having an end surface that faces the extraneous matter-discharging oil chamber and a second land having an end surface that faces the line pressure oil chamber are integrally formed.

16. The automatic transmission fail-safe mechanism according to claim 1, wherein the first valve unit is a plunger.

17. The automatic transmission fail-safe mechanism according to claim 1, wherein the fail-safe valve is a clutch apply control valve.

18. A fail-safe valve provided in the automatic transmission fail-safe mechanism according to claim 1, wherein a valve element and the first valve unit are coaxially inserted so as to be movable relative to each other within a valve body, and a spring that urges the valve element toward the non-failure position is attached between the valve body and the valve element, and the first valve unit moves from the non-failure position toward the failure position as the extraneous matter-discharging oil pressure acts between the valve element and the first valve unit.

19. The automatic transmission fail-safe mechanism according to claim 8, further comprising:
a first oil passageway as a supply oil passageway of the oil pressure for positioning the predetermined gearshift;
a second oil passageway as a drain oil passageway;
a branch oil passageway that connects the first oil passageway and the second oil passageway in communication; and
a second valve unit provided in the second oil passageway at a drain side of a connecting position between the second oil passageway and the branch oil passageway,
wherein if the predetermined friction engagement element is engaged during the non-failure state of the automatic transmission, the oil pressure for engaging the predetermined friction engagement element is supplied via the branch oil passageway to an extraneous matter-discharging oil chamber by closing the second valve unit, so that the oil pressure acts on the fail-safe valve as the extraneous matter-discharging oil pressure.

20. The automatic transmission fail-safe mechanism according to claim 8, wherein a valve element and the first valve unit are in contact with each other, and when a predetermined friction engagement element of the plurality of friction engagement elements is engaged during the non-failure state of the automatic transmission, the valve element moves together with the first valve unit from the non-failure position toward the failure position.

21. The automatic transmission fail-safe mechanism according to claim 6, wherein an outside diameter of a pressure receiving area of an end surface of the first valve unit that faces the extraneous matter-discharging oil chamber is set approximately 1.2 times as large as an outside diameter of a pressure receiving area of an end surface of the first valve unit that faces the line pressure oil chamber.

22. The automatic transmission fail-safe mechanism according to claim 11, wherein an outside diameter of a pressure receiving area of an end surface of the first valve unit that faces the extraneous matter-discharging oil chamber is set approximately 1.2 times as large as an outside diameter of a pressure receiving area of an end surface of the first valve unit that faces the line pressure oil chamber.

23. The automatic transmission fail-safe mechanism according to claim 6, wherein in the first valve unit, a first land having an end surface that faces the extraneous matter-discharging oil chamber and a second land having an end surface that faces the line pressure oil chamber are integrally formed.

24. The automatic transmission fail-safe mechanism according to claim 11, wherein in the first valve unit, a first land having an end surface that faces the extraneous matter-discharging oil chamber and a second land having an end surface that faces the line pressure oil chamber are integrally formed.

25. The automatic transmission fail-safe mechanism according to claim 6, wherein the first valve unit is a plunger.

26. The automatic transmission fail-safe mechanism according to claim 8, wherein the first valve unit is a plunger.

27. The automatic transmission fail-safe mechanism according to claim 6, wherein the fail-safe valve is a clutch apply control valve.

28. The automatic transmission fail-safe mechanism according to claim 8, wherein the fail-safe valve is a clutch apply control valve.

29. A fail-safe valve provided in the automatic transmission fail-safe mechanism according to claim 6, wherein a valve element and the first valve unit are coaxially inserted so as to be movable relative to each other within a valve body, and a spring that urges the valve element toward the non-failure position is attached between the valve body and the valve element, and the first valve unit moves from the non-failure position toward the failure position as the extraneous matter-discharging oil pressure acts between the valve element and the first valve unit.

30. A fail-safe valve provided in the automatic transmission fail-safe mechanism according to claim 8, wherein a valve element and the first valve unit are coaxially inserted so as to be movable relative to each other within a valve body, and a spring that urges the valve element toward the non-failure position is attached between the valve body and the valve element, and the first valve unit moves from the non-failure position toward the failure position as the extraneous matter-discharging oil pressure acts between the valve element and the first valve unit.
